(19) United States
(12) Patent Application Publication
(10) Pub. No.: US 2013/0021507 A1
(43) Pub. Date: Jan. 24, 2013

(54) IMAGE PROCESSORS AND METHODS FOR PROCESSING IMAGE DATA

(71) Applicants: Ynjiun Paul Wang, Cupertino, CA (US); Shulan Deng, San Jose, CA (US)

(72) Inventors: Ynjiun Paul Wang, Cupertino, CA (US); Shulan Deng, San Jose, CA (US)

(73) Assignee: HAND HELD PRODUCTS, INC., Skaneateles Falls, NY (US)

(21) Appl. No.: 13/188,696

(22) Filed: Jul. 22, 2011

(51) Int. Cl. H04N 9/04

(52) U.S. Cl. 348/273; 348/272; 348/E09.002

(57) ABSTRACT

Image processors and methods of processing image data from monochrome and color sensors, for example, pixels, are provided. The exposure time of the monochrome pixels is limited and the exposure time of the color pixels is extended to enhance image quality while limiting the “cross talk” that can interfere with prior art methods and devices. The monochrome and color sensors may be provided in two-dimensional image sensor arrays which can be provided in optical readers, for example, portable hand-held optical readers. Aspects of the invention can be applied to visual imaging, for example, in bar code or image handling applications, and to the detection and processing of any form of electromagnetic radiation.

### BACKGROUND OF THE INVENTION

1. Field of the Invention

The present invention relates, generally, to methods and systems for capturing and processing images, and particularly, to capturing and processing images while varying the exposure times for capturing monochrome image data and color image data and then combining the image data to produce color images.

2. Description of Related Art

Two types of light-sensitive photoreceptor cells are found in the human retina. These two types are referred to as “rod cells” and “cone cells.” It is understood that these two types of cells differ in function. Rod cells are believed to contribute to the ability to see at night under very dim light conditions. Cone cells are believed to be primarily function to distinguish between colors under normal lighting conditions.

However, studies have shown that for every 20 rod cells there is approximately only 1 cone cell. This variation in the relative number of rod and cone cells was recognized by Dr. Ynjiun Wang when developing the optic arrays disclosed in U.S. patent application Ser. No. 11/174,447 filed on Jun. 30, 2005 [herein “the '447 application”], now U.S. Pat. No. 7,780,089 (other patents pending), marketed under the term “MonoColor” imaging. The MonoColor image array is designed to mimic human optic receptors. For example, in MonoColor imaging there may be 15 monochrome pixels in the sensor array for every one color pixel in the array.

The optical sensor arrays disclosed in the '447 application provide a way to efficiently obtain both monochrome and color images in a single sensor. As described herein, and as will be understood by those in the art digital imaging, the term “monochrome” means that the sensor or image detects or contains shades of gray between white and black. The term “grayscale” is also associated with monochrome digital imaging.

Aspects of the present invention provide systems, devices, and methods that overcome the limitations of the prior art.

### SUMMARY OF ASPECTS OF THE INVENTION

The present inventors have shown through experimentation that, with post processing, monochrome and color image data can be used to generate color images by employing the systems and methods disclosed in the '447 application. In conventional methods, “noise,” for example, due to lower pixel sensitivity and lower pixel resolution can negatively affect the quality of color image sensing and display, including the detection of what are known as “Bayer pattern” sensors. However, when employing the teachings of the '447 application, red-green-blue (RGB) color filters are significantly outnumbered by monochrome filters whereby pixel sensitively and pixel resolution may be increased thus producing much brighter and much sharper color images given the amount of exposure time under a dim light condition.

It is also recognized by the inventors that movement of the optical sensor, for example, due to hand motion by the operator, can interfere with the quality of the image detected. Blurred pictures due to an unsteady hand are the bane of even professional photographers. This issue is not only problematic for digital imaging, but also to symbol detection and decoding, for example, of bar codes or quick response (QR) codes, among others.

The present inventors recognized two observations concerning the imaging, for example, photographing, of color images: (1) a shorter exposure time leads to a sharper image with more contrast and details, and (2) when capturing a color image, a longer exposure time is typically required. Shortening the exposure time can result in an image that retains better edge or contour information of the objects being imaged. Longer exposure time for color images can preserve better color content, but the longer time can be susceptible to hand motion blur.

Accordingly, the present inventors have developed a novel approach to improve color signal quality when digitally capturing images in color-sensitive applications. According to aspects of the invention, a first monochrome image is taken over a relatively short exposure time to minimize the effect of motion and provide the desired sharper image with more contrast, details, and better edge or contour information of the objects being imaged. A second color image is taken over a relatively longer exposure time to provide better color content. The image data are combined through digital image data processing to provide high quality color images.

According to aspects of the invention, monochrome photo sensors, for example, monochrome pixels, may be provided with a shorter exposure time while color-filtered photo sensors, for example, color-filtered pixels, may be provided with a longer exposure time. The monochrome image data from the short exposure time are combined with the color image data for the longer exposure time to produce color images. Typically, two exposure instances or frames—one monochrome and one color—may be used to implement aspects of the invention. The monochrome image data and the color image data may be combined using the methods and procedures disclosed in the '447 application, the disclosure of which is incorporated by reference herein in its entirety, among others. By employing aspects of the invention, high quality color images can be obtained.

One embodiment of the present invention is an image processing apparatus comprising: a two-dimensional solid state image sensor array comprising: a first set of monochrome pixels that are devoid of wavelength selective filter elements; and a second set of color sensitive pixels that include wavelength selective filter elements; wherein the image processing apparatus is adapted to expose the image sensor array for a first exposure time e₀ and generate first image data, and to expose the image sensor array for a second exposure time e₁ greater than the first exposure time e₀ and generate second image data; and wherein the image processing apparatus is adapted to combine the first image data and the second image data to produce combined image data. In one aspect, the time e₁ is at least 50% greater than time e₀, for example, is at least 100% greater than time e₀. For example, in one aspect, time e₁ is greater than 10 milliseconds and time e₀ is less than 5 milliseconds.

In one aspect, the first exposure time e₀ and the second exposure time e₁ are initiated at substantially simultaneously. In another aspect, the first exposure time e₀ is initiated at first time t₀ and the second exposure time e₁ is initiated at a second time t₁, and wherein the first time t₀ leads the second time t₁. In another aspect, the first time t₀ lags the second time t₁. For example, in one aspect, first time t₀ may be a start time for a first frame and second time t₁ may be a start time for a second frame, and the first exposure time e₀ may be the exposure time for the first frame and the second exposure time e₁ may be the exposure time of the second frame.

Another embodiment of the invention is a portable data collection device comprising the image processing apparatus described above.

Another embodiment of the invention is a method of processing image data comprising or including the steps of: (a) sensing a monochrome image for an exposure time e₀, and generating monochrome image data; b) sensing a color image for an exposure time e₁ greater than e₀, and generating color image data; and (c) processing the monochrome image data and the color image data to produce combined color image data. In one aspect, sensing the monochrome image may be practiced with a set of monochrome pixels that are devoid of wavelength selective filter elements; and sensing the color image may be practiced with a set of color sensitive pixels having a wavelength selective filter element. In another aspect, sensing the monochrome image and sensing the color image may be practiced with a set of monochrome pixels that are devoid of wavelength selective filter elements and a set of color sensitive pixels having a wavelength selective filter element, and wherein the monochrome image data is extracted from the set of monochrome pixels and the color image data is extracted from the set of color-sensitive pixels. Again, in one aspect, the time e₁ may be at least 50% greater than time e₀, for example, at least 100% greater than time e₀. In one aspect, processing may comprise decoding, demosaicking, and/or fusioning.

A still further embodiment is a method of collecting electromagnetic radiation, said method comprising or including (a) sensing of electromagnetic radiation having a first range of wavelength, for example, monochrome, with a first set of sensors for an exposure time e₀, and generating a first electrical signal corresponding to the sensed radiation; (b) sensing electromagnetic radiation having a second range of wavelength different from the first range of wavelength, for example, a color image, with a second set of sensors for an exposure time e₁ greater than e₀, and generating a second electrical signal corresponding to the sensed radiation; and (c) processing the first electrical signal and the second electrical signal to produce a third electrical signal corresponding to a combined first sensed radiation and second sensed radiation. The first set of sensors and the second set of sensors may comprise the same set of sensors. In one aspect, the first set of sensors comprise monochrome sensors and the second set of sensors comprise at least one color sensor. In another aspect, at least one color sensor comprises at least one color filter and at least one photo sensor, such as, a photodiode. In another aspect, the monochrome sensors comprise monochrome pixels and the at least one color sensor comprises color pixels. In one aspect, the electromagnetic radiation having the first range of wavelength and the electromagnetic radiation having the second range of wavelength comprise one or more of microwave radiation, terahertz radiation, infrared radiation, visible light, ultraviolet radiation, X-rays, gamma ray radiation, and radio waves.

A still further embodiment of the invention is an apparatus for processing electromagnetic radiation comprising or including: a first set of sensors adapted to detect electromagnetic radiation having a first range of wavelength for an exposure time e₀, and to generate a first electrical signal corresponding to the detected radiation; a second set of sensors adapted to detect electromagnetic radiation having a second range of wavelength different from the first range of wavelength for an exposure time e₁ greater than e₀, and to generate a second electrical signal corresponding to the detected radiation; wherein the apparatus is adapted to process the first electrical signal and the second electrical signal to produce a third electrical signal corresponding to the combined first detected radiation and second detected radiation. The first set of sensors and the second set of sensors may comprise the same set of sensors. In one aspect, the first set of sensors comprises monochrome sensors and the second set of sensors comprise at least one color sensor. In another aspect, the at least one color sensor comprises at least one color filter and at least one photo sensor, such as, a photodiode. In a further aspect, the monochrome sensors comprise monochrome pixels and the at least one color sensor comprises color pixels. In one aspect, the electromagnetic radiation may be any of the forms of electromagnetic radiation listed above.

Details of these embodiments and aspects of the invention, as well as further aspects of the invention, will become more readily apparent upon review of the following drawings and the accompanying claims.

### BRIEF DESCRIPTION OF THE FIGURES

The subject matter that is regarded as the invention is particularly pointed out and distinctly claimed in the claims at the conclusion of the specification. The foregoing and other features and advantages of the invention will be readily understood from the following detailed description of aspects of the invention taken in conjunction with the accompanying drawings in which:

FIG. 1 is a schematic diagram of an image processor and a method for processing image data according to one aspect of the invention.

FIG. 2A is an image capture initiation control signal timing diagram for a separate reset according to one aspect of the invention.

FIG. 2B is an image capture initiation control signal timing diagram for single reset according to another aspect of the invention.

FIG. 3 is a partial, high-level electrical block diagram of an embodiment of an image sensor according to an aspect of the invention.

FIG. 4 is a partial electrical block diagram of an image sensor array according to one aspect of the invention.

FIG. 5 is a perspective view of solid state image sensor array and a partial magnified top view of the image sensor array according to an aspect of the invention.

### DETAILED DESCRIPTION OF FIGURES

The details and scope of the aspects of the present invention can best be understood upon review of the attached figures and their following descriptions. As noted previously, aspects of the presented invention are related to what is disclosed in U.S. patent application Ser. No. 11/174,447 filed on Jun. 30, 2005 [herein “the '447 application”], now U.S. Pat. No. 7,780,089 (other patents pending), the disclosure of which is incorporated by reference herein in its entirety.

Aspects of the present invention disclosed herein may be implemented in any one or more of the structures, devices, systems, software, or processes, disclosed in the '447 application, including, but not limited to, the optical readers; the hardware, such as, the displays, graphical user interfaces (GUIs), and other I/O devices; the software; the image sensor arrays, including polarizer image sensor arrays; the imaging modules; the sensors, including monochrome and color-sensitive pixels; the integrated circuits and chips; the circuits; the controls; the flow diagrams; the routines, including decoding, demosaicking, and fusioning routines; the timing diagrams; the frames of image data; the block diagrams; the curvelent detector maps; the histograms; and the image data segmentation processes, among other disclosures of the '447 application.

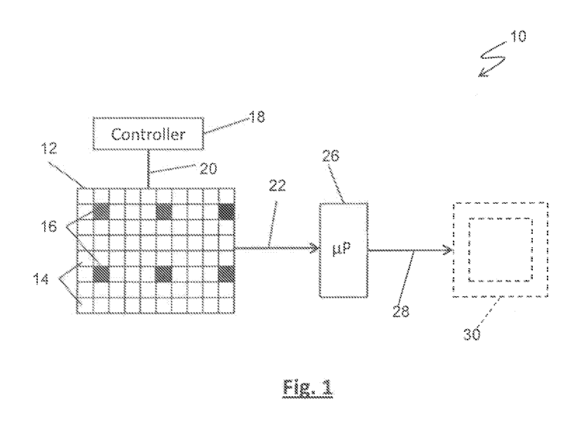

FIG. 1 is a schematic diagram of an image processor or imaging processing apparatus 10 and a method for processing image data according to aspects of the invention. As shown, image processor 10 includes an array 12 of a plurality of monochrome pixels 14 and color sensitive pixels 16, for example, a two-dimensional solid state image sensor array 12 comprising monochrome pixels 14 and color sensitive pixels 16. Image processor or image processing apparatus 10 includes a controller 18 operatively connected to array 12, for example, by connection 20. Controller 18 is adapted to expose the image sensor array 12 for a first exposure time, e₀, and generate first image data, for example, a first frame image data, represented by line 22, and to expose the image sensor 12 array for a second exposure time, e₁, greater than the first exposure time, e₀, and generate second image data, for example, a second frame image data. As also shown in FIG. 1, image processor 10 includes a processor 26 adapted to received first frame image data and second frame image data and combine the first image data and the second image data to produce combined image data, for example, combined color image data, represented by line 28. The combined image data 28 may be forwarded for further processing, storage, or output, for example, on display 30, shown in phantom in FIG. 1. According to aspects of the invention, by limiting the first exposure time e₀ and extending the second exposure time e₁, for example, an order of magnitude greater than e₀, the combined image data can produce an image having enhanced feature definition while providing desirable color retention.

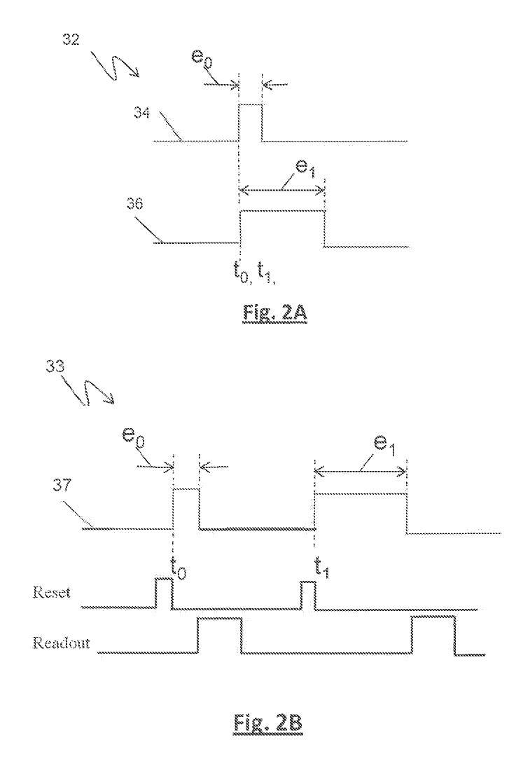

FIG. 2A is an image capture initiation control signal timing diagram 32 for a separate reset according to one aspect of the invention. As suggested in FIG. 2A, the initiation of the exposure of the first frame for an exposure time e₀, for example, of the monochrome pixels 14, that is, at time t₀, and the initiation of the exposure of the second frame for an exposure time e₁, for example, exposure of the color-sensitive pixels 16, that is, time t₁, may occur substantially simultaneously, for example, time t₀≈time t₁, for example, if a separate reset control circuitry is used as disclosed in '447. In this mode of operation, only one frame is required to capture both monochrome image data and color image data with different exposure times. However, for the diagram 32 shown in FIG. 2A (and in FIG. 2B), according to aspects of the invention, the initiation of the exposure of the first frame for time e₀ may also occur prior to the initiation of the exposure of the second frame for time e₁, that is, time t₀ may be less than time t₁. Conversely, the initiation of the exposure of the first frame may also occur after the initiation of the exposure of the second frame, that is, time t₀ may be greater than time t₁. For example, in one aspect, e₀ may be greater than e₁, and the color image data may be extracted from the first frame and the monochrome image data may be extracted from the second frame.

FIG. 2B is an image capture initiation control signal timing diagram 33 according to one aspect of the invention. A shown in FIG. 2B, in one aspect, a sequence of frames of images are taken, for example, each frame may be initiated at a frame initiation time, for instance, at a typical vertical synchronization (or Vsync) time, followed by an exposure time and a readout time. The exposure time typically is defined by between the reset and the readout if a rolling shutter control is used, or is defined by between the reset and transfer if a global shutter control is used (not shown in FIG. 2B). The According to one aspect of the invention, a “frame” comprises the image data detected during a time interval, for example, time interval between Vsync enable. According the aspect shown in FIG. 2B, a first exposure control signal 37 defines the initiation at t₀ and termination of a first exposure time e₀, for example, an exposure time of the first frame, from which monochrome pixels can be extracted to form a monochrome image data, and a second exposure control signal 37 defines the initiation at t₁ and termination of a second exposure time e₁, for example, the exposure time of the second frame, from which color pixels can be extracted to form color image data. As shown in FIG. 2B, the duration of the first exposure time e₀ is characteristically shorter than the duration of second exposure time e₁, for example, the first exposure time e₀ may be less than 5 milliseconds [ms] while the duration of the second exposure time e₁ is longer, for example, at least 10 ms. According to aspects of the invention, time e₁ may be at least 50% greater than time e₀, for example, time e₁ may be at least 100% greater than time e₀, or at least three times the time e₀. In one aspect, time e₁ may be greater than about 10 milliseconds, for example, about 15 to about 50 ms, and time e₀ may be less than about 5 ms, for example, less than about 1 ms, or even within the range of about 500 to about 1000 microseconds [μs].

In one aspect, the first exposure time e₀ and the second exposure time e₁ may be established depending upon or as a function of the presence of ambient light or external illumination. For example, in the presence of outdoor sunlight at or about noon time, that is, under highly illuminated conditions, the first exposure time e₀ may be about 100 μs and the second exposure time e₁ may range from about 200 μs to about 400 μs. However, according to one aspect of the invention, regardless of the absolute lengths of exposure times e₀ and e₁, second exposure time e₁ may be greater than first exposure time e₀, for example, e₁ may be at least twice as long as eₒ and may be at least three times as long as eₒ. Though not shown in FIGS. 2A or 2B, the first frame having exposure time e₀ and the second frame having exposure time e₁ may be repeated at least once, but typically repeated a plurality of times.

Aspects of the invention may be implemented in any form of image processing device, for example, in the devices shown in and described with respect to FIGS. 9A, 9B, and 9C of the '447 application. In one aspect of the invention, the collection of image data from image sensor array 12 may be practiced by detecting image data during the first frame for exposure time e₀ by employing monochrome pixels 14 only, and by detecting image data during the second frame for exposure time e₁ by employing color-sensitive pixels 16 only. However, in another aspect of the invention, image data may be detected with both monochrome pixels 14 and color-sensitive pixels 16 for exposure time e₀, for example, 5 ms, and only the image data from the monochrome pixels 14 may be used for further processing, that is, combining with image data from the second frame of exposure time e₁. Similarly, image data may be detected with both monochrome pixels 14 and color-sensitive pixels 16 for exposure time e₁, for example, 15 ms, and only the image data from the color-sensitive pixels 16 may be used for further processing, for example, combining with the image data from the first frame of exposure time e₀.

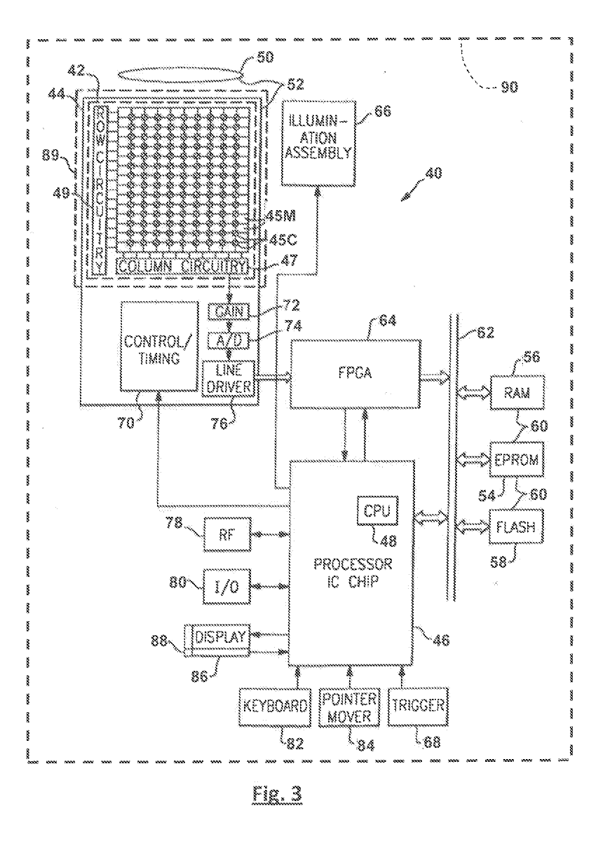

FIG. 3 is a schematic block diagram of an a optical device 40, for example, an optical reader, having an image sensor array 42, that may be similar to sensor array 12, that may be used to implement image processor or image processing apparatus 10 shown in FIG. 1 according to aspects of the invention. In the following discussion device 40 will be referred to as “reader” or “optical reader,” but it is to be understood that device 40 may be any device where electromagnetic radiation is being detected, for example, visible light, and an image produced.

Reader 40 includes an image sensor array 42, for example, a solid state image sensor array 42. Sensor array 42 may be incorporated on an image sensor integrated circuit chip 44 shown in FIG. 3 as a complementary metal-oxide semiconductor (CMOS) image sensor integrated circuit (IC) chip. As will be described further below, according to aspects of the invention, image sensor array 42 includes a plurality of first sensors 45C, for example, color sensitive pixels, and wavelength sensitive color filter elements associated with the first sensors 45C, and a plurality of second sensors 45M, for example, monochrome pixels, for instance, sensors that are devoid of associated wavelength selective filter elements. Since image sensor array 42 includes both monochrome pixels 45M and color-sensitive pixels 45C, image sensor array 42 may be termed a “hybrid” monochrome and color image sensor array or a “MonoColor” sensor array.

Image sensor array 42 typically includes a two-dimensional grid of interconnects which are in electrical communication with respective column circuitry 47 and row circuitry 49. Row circuitry 49 and column circuitry 47 typically enable processing and operational tasks, such as, selectively addressing pixels 45M, 45C; decoding pixels 45M, 455C; amplification of signals, analog-to-digital conversion, applying timing, read out and reset signals, and the like.

Monochrome pixels 45M may comprise the same design and construction of the monochrome pixel 250M shown in FIGS. 3A and 3B of the '447 application, or its equivalent. Color-sensitive pixels 45C may comprise the same design and construction of the color pixel 250C shown in FIGS. 3C and 3D of the '447 application, or its equivalent.

Reader 40 may further include a processor IC chip 46 and a control circuit 48. Control circuit 48 as shown in the embodiment of FIG. 3 may be provided by a central processing unit (CPU) of processor IC chip 46. In other embodiments, control circuit 48 may be provided by, for example, a programmable logic function execution device, such as, a field programmable gate array (FPGA) or an application specific integrated circuit (ASIC).

As also shown in FIG. 3, reader 40 may typically include an imaging lens 50 adapted to focus images onto an active surface of image sensor array 42 and, together with image sensor array 42, form an imaging assembly 52. Control circuit 48 may execute picture taking and indicia decoding algorithms in accordance with instructions stored in program memory 542, for example, an EPROM, which, together with RAM 56 and flash memory 58 may form a reader memory 60. Reader memory 60 may typically be in communication with processor IC chip 46 via system bus 62. Processor IC chip 46, for example, a main processor chip, may be a multifunctional IC chip, such as, an XSCALE PXA25x processor IC chip or its equivalent, and may include central processing unit (CPU) 48.

Reader 40 may further include a field programmable gate array (FPGA) 64. Operating under the control of control circuit 48, FPGA 64 receives digital image data from image sensor IC chip 44 and transfers that image data into RAM 56 so that the image data can be further processed (for example, by the decoding of a bar code symbol). Processor IC chip 46 can include an integrated frame grabber. For example, processor IC chip 46 may be an XSCALE PXA27X processor IC chip with “Quick Capture Camera Interface” available from INTEL, or its equivalent. When processor IC chip 46 includes an integrated frame grabber, the integrated frame grabber may provide the frame acquisition functionality of FPGA 60.

Reader 40 may typically further include an illumination assembly 66 and a trigger 68, for example, a manual trigger. Image sensor IC chip 44 in the embodiment of FIG. 3 may include an on-chip control/timing circuit 70, an on-chip gain circuit 72, an on-chip analog-to-digital converter 74, and an on-chip line driver 76.

According to aspects of the invention, reader 40 may include a radio frequency (RF) communication interface 78. Radio frequency communication interface 78 may include one or more radio transceivers, for example, radio frequency communication interface 78 may include one or more of an 802.11 radio transceiver, a Bluetooth radio transceiver, a GSM/GPS radio transceiver or a WIMAX (802.16) radio transceiver. Radio frequency communication interface 78 may facilitate wireless communication of data between device 40 and a distal, remote, or spaced apart device (not shown). Reader 40 may also include an I/O communication interface 80. Interface 80 may include one or more serial or parallel hard-wired communication interfaces facilitating communication with a spaced apart device (not shown). I/O communication interface 80 may include one or more of an Ethernet communication interface, a universal serial bus (USB) interface, or an RS-232 communication interface. Optical reader 40 may further include a keyboard 82 for entering data, a pointer mover 84 for moving a pointer of a graphical user interface (GUI) and a trigger 68 for initiating bar code reading and/or picture taking. Optical reader 40 may also include a display 86 for displaying image data, such as, a monochrome or color LED display and a touch screen 88 overlaid over display 86.

An image sensor array 42 which is incorporated into optical reader 40 may take a variety of forms. In FIG. 3, reader 40 includes first image sensor array 42. However, as indicated by hardware block 89, the image sensor array 42 may be interchangeable or replaceable with another image sensor array. In other embodiments, optical reader 40 may include more than one image sensor array 42, for example, a plurality of image sensor arrays 42, or a plurality of different image sensor arrays, for example, with varying sensor types, sensor locations, and/or sensor configurations. Various embodiments of image sensor arrays which may be incorporated into reader 40 are described herein, and in the '447 application.

All of the components of FIG. 3 may be encapsulated and supported by a housing 90 (shown in phantom in FIG. 3), for example, a hand-held housing. Additional features and functions of the components of reader 40 shown in FIG. 3 are described herein and in the '447 application.

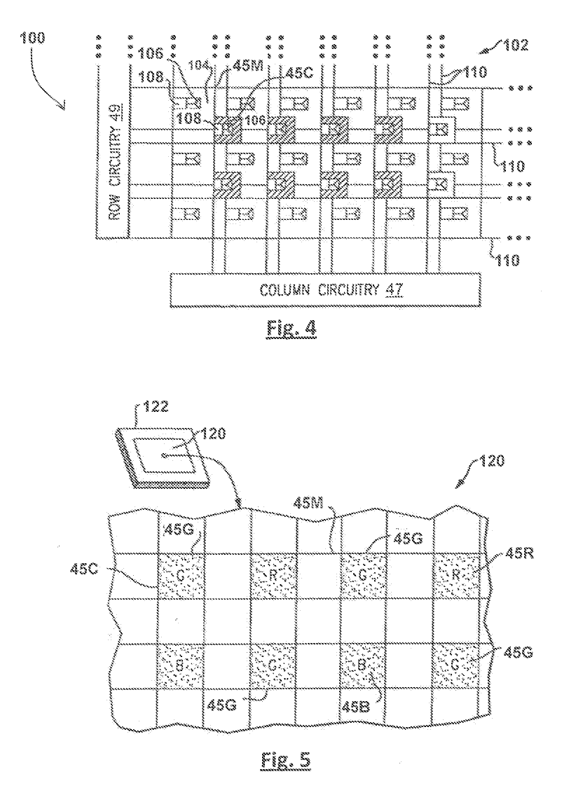

FIG. 4 is a partial, high-level electrical block diagram 100 of an embodiment of an image sensor array 102 having photosensitive regions 104 according to an aspect of the invention, for example, image sensor array 102 may be used for array 42 shown in FIG. 3. According to aspects of the invention, any image sensor array may be used, for example, any one of the image sensor arrays disclosed in the '447 application; however, in one aspect, the image sensor array 102 is an “active pixel” image sensor array of complementary metal oxide semiconductor (CMOS) construction having monochrome pixels 45M and color pixels 45C. Each pixel 45M, 45C, whether from the monochrome first subset of pixels or the color sensitive second subset of pixels, may typically be an active pixel. That is, each pixel 45M and 45C typically may include a pixel amplifier 106 for amplifying signals corresponding to light incident on photosensitive region 104. Each pixel 45M, 45C may also include an optically shielded storage element 108. Image sensor array 102 further includes two-dimensional grid of interconnects 110 which are in electrical communication with respective column circuitry 47 and row circuitry 49. Row circuitry 49 and column circuitry 47 enable such processing and operational tasks, such as, selectively addressing pixels, decoding pixels, amplification of signals, analog-to-digital conversion, applying timing, read out and reset signals, and the like.

FIG. 5 is a perspective view of solid state image sensor array 120 mounted on an IC chip 122, and a partial, magnified top view of the image sensor array 120 according to an aspect of the invention. IC chip 122 may be similar to and have all the attributes of IC chip 44 shown in FIG. 3. As shown in FIG. 5, image sensor array 120 includes a plurality of square shaped pixels 45M, 45C (as seen in the top view shown) positioned in a “checkerboard” pattern. Though the size, shape, orientation, and pattern of pixels 45M and 45C may vary, for ease of illustration, each of the pixels shown in FIG. 4 have substantially the same dimensions in a regular two-dimensional pattern. Each pixel 45M, 45C of image sensor array 120 may be constructed to have approximately the same top surface dimensions as seen from the top view of FIG. 5 and approximately the same side view cross-sectional dimensions as seen from the cross-sectional views of FIGS. 6A-6D of the '447 application. Image sensor array 120 may be similar to the construction of a standard off-the-shelf monochrome image sensor array except that select pixels of the image sensor array 120 have an associated wavelength selective color filter element.

Solid state image sensor array 120 includes a plurality of pixels formed in a plurality of, typically, adjacent rows. In the aspect shown in FIG. 5, a monochrome first subset of pixels 45M comprise the majority of pixels of the sensor array 120. Wavelength selective color filter elements may be included in the second subset of color sensitive pixels 45C. The color sensitive second subset of pixels 45C comprises pixels at spaced apart pixel positions uniformly distributed or substantially uniformly distributed throughout the plurality of pixels forming the image sensor array 120. In the embodiment of FIG. 5, every other pixel in every other row of pixels (for example, pixel row 2, 4, 6 . . .) has an associated wavelength selective color filter element (for example, as shown in FIGS. 6A-6D of the '447 application).

In one example of the invention, image sensor array 120 may be provided by including an appropriately designed color filter array on an image sensor array of an MT9M111 Digital Clarity SOC 1.3 megapixel CMOS image sensor IC chip of the type available from Micron, Inc.; an MT9V022 image sensor IC chip also available from Micron, Inc.; a VV6600 1.3 megapixel CMOS image sensor IC chip of the type available from STMicroelectronics; a Jade MonoColor sensor having part number is EV76C454BMT-EQV provided by e2V; or their equivalent. Other image sensor IC chips which can be utilized to provide image sensor array 120 include MT9M413 image sensor IC chip available from Micron, Inc., a KAC-0311 image sensor IC chip manufactured by Kodak, Inc. a KAI-0340 image sensor IC chip also manufactured by Kodak, Inc., or their equivalent. Operational aspects of the referenced KAI-0340 image sensor IC chip are described further the '447 application. Various manufacturer product description materials respecting certain of the above image sensor IC chips are appended to provisional patent applications cited in the '447 application. The above commercially sold image sensor IC chips can be utilized (with additions or replacements of filter elements as are necessary) to provide any one of image sensor arrays 120 and others described herein and in the '447 application.

As shown in FIG. 5, wavelength selective color filter elements (filters) on sensor array 120 may be formed on color sensitive pixels 45C. Array 120 may comprise a combination of colors, for example, red-green-blue (RGB) or cyan-magenta-yellow (CMY), among others. As shown in FIG. 5, color sensitive pixels 45C may comprise red filter elements 45R, green filter elements 45G, and/or blue filter elements 45B. Because cyan and magenta filters require only one dye and not two dyes (as in red green and blue filters), a CMY filer element allows more light to pass through to a photodetector (for example, to photodetector 302 shown in FIG. 6c of the '447 application) and exhibits a higher signal to noise ratio than the embodiment of FIG. 5, though the color filter arrangement shown in FIG. 5 may be preferred for certain applications. Other filter arrays, such as those disclosed in FIGS. 5A through 7D of the '447 application, may also be employed for aspects of the invention.

Typical exposure control timing pulses, read out control timing pulse, and reset control timing pulse that may be used for aspects of the invention are shown in FIGS. 15A through 15D of the '447 application.

The image data captured by aspects of the invention may be processed, for example, demosaicked, decoded, fused, or combined, by, for example, any one or more of the methods or routines disclosed in the '447 application. For example, monochrome image data captured by monochrome pixels 45M and color sensitive pixels 45C may be processed by one or more of the processes described and illustrated with respect to FIGS. 14A through 14I of the '447 application, for example, the methods described in FIG. 14I of the '447 application.

Though aspects of the invention have been disclosed herein as almost exclusively dealing with the handling of visual image data. According to aspects of the invention, any form of electromagnetic radiation may be captured and processed with the methods, systems, and devices disclosed herein and in the '447 application. For example, the methods, systems, and devices disclose herein may capture and manipulate image data related to one or more of microwave radiation, terahertz radiation, infrared radiation, visible light, ultraviolet radiation, X-rays, gamma ray radiation, and radio waves.

Aspects of the present invention provide devices and methods for digital color imaging that minimize the effect of sensor motion and cross talk between sensors. As will be appreciated by those skilled in the art, features, characteristics, and/or advantages of the various aspects described herein, may be applied and/or extended to any embodiment (for example, applied and/or extended to any portion thereof).

Although several aspects of the present invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. An image processing apparatus comprising:
a two-dimensional solid state image sensor array comprising:
a first set of monochrome pixels that are devoid of wavelength selective filter elements; and
a second set of color sensitive pixels that include wavelength selective filter elements;
wherein the image processing apparatus is adapted to expose the image sensor array for a first exposure time e₀ and generate first image data, and to expose the image sensor array for a second exposure time e₁ greater than the first exposure time e₀ and generate second image data; and
wherein the image processing apparatus is adapted to combine the first image data and the second image data to produce combined image data.

2. The image processing apparatus as recited in claim 1, wherein time e₁ is at least 50% greater than time e₀.

3. The image processing apparatus as recited in claim 1, wherein time e₁ is at least 100% greater than time e₀

4. The image processing apparatus as recited in claim 1, wherein time e₁ is at least three times the time e₀.

5. The image processing apparatus as recited in claim 1, wherein time e₁ is greater than 10 milliseconds and time e₀ is less than 5 milliseconds.

6. The image processing apparatus as recited in claim 1, wherein the second exposure time e₁ is initialed after the first exposure time e₀.

7. The image processing apparatus as recited in claim 1, wherein the first exposure time e₀ is initiated at first time t₀ and the second exposure time e₁ is initiated at a second time t₁, and wherein the first time t₀ leads the second time t₁.

8. The image processing apparatus as recited in claim 1, wherein the first exposure time e₀ is initiated at first time t₀ and the second exposure time e₁ is initiated at a second time t₁, wherein the first time t₀ lags the second time t₁.

9. The image processing apparatus as recited in claim 1, wherein the image processing apparatus further comprises a display adapted to display the combined image data.

10. A portable data collection device comprising the image processing apparatus recited in claim 1.

11. A method of processing image data comprising:
(a) sensing a monochrome image for an exposure time e₀, and generating monochrome image data;
(b) sensing a color image for an exposure time e₁ greater than e₀, and generating color image data; and
(c) processing the monochrome image data and the color image data to produce combined color image data.

12. The method as recited in claim 11, wherein sensing the monochrome image is practiced with a set of monochrome pixels that are devoid of wavelength selective filter elements; and
sensing the color image is practiced with a set of color sensitive pixels having a wavelength selective filter element.

13. The method as recited in claim 11, wherein sensing the monochrome image and sensing the color image are practiced with a set of monochrome pixels that are devoid of wavelength selective filter elements and a set of color sensitive pixels having a wavelength selective filter element; and wherein the monochrome image data is extracted from the set of monochrome pixels; and wherein the color image data is extracted from the set of color sensitive pixels.

14. The method as recited in claim 11, wherein time e₁ is at least 50% greater than time e₀.

15. The method as recited in claim 11, wherein time e₁ is at least 100% greater than time e₀.

16. The method as recited in claim 11, wherein time e₁ is greater than 10 milliseconds and time e₀ is less than 5 milliseconds.

17. The method as recited in claim 11, wherein the first exposure time e₀ is initiated at first time t₀ and the second exposure time e₁ is initiated at a second time t₁, and wherein the first time t₀ leads the second time t₁.

18. The method as recited in claim 11, wherein the first exposure time e₀ is initiated at first time t₀ and the second exposure time e₁ is initiated at a second time t₁, wherein the first time t₀ lags the second time t₁.

19. The method as recited in claim 11, wherein processing comprises one or more of decoding, demosaicking, and fusioning.

20. The method as recited in claim 11, wherein the set of monochrome pixels and the set of color sensitive pixels are provided on a two-dimensional solid state image sensor array.
